(19) United States
(12) Patent Application Publication
(10) Pub. No.: US 2026/0330770 A1
(43) Pub. Date: Oct. 22, 2026

(54) METAVERSE ENVIRONMENT PROMPT TUNING

(71) Applicant: International Business Machine Corporation, Armonk, NY (US)

(72) Inventors: Scott E. SCHNEIDER, Rolesville, NC (US); Sarbajit Kumar RAKSHIT, Kolkata (IN); Perla Guadalupe REYES RAMIREZ, Zapopan (MX); Carolina GARCIA DELGADO, Zapopan (MX)

(21) Appl. No.: 19/185,352

(22) Filed: Apr. 22, 2025

(51) Int. Cl. G06T 19/00; G06F 40/166; G06F 40/289

(52) U.S. Cl. CPC G06T 19/00; G06F 40/166; G06F 40/289

(57) ABSTRACT

In some implementations, a computer may segment a metaverse environment into multiple virtual components that are associated with respective interaction modes. The computer may detect a virtual interaction with a virtual component of the multiple virtual components, wherein the virtual interaction is associated with contextual information. The computer may identify, based on detecting the virtual interaction, one or more prompt tuning parameters for a generative model, wherein the one or more prompt tuning parameters are based on the contextual information and an interaction mode associated with the virtual component. The computer may tune, based on the one or more prompt tuning parameters, one or more prompts of the generative model to obtain one or more tuned prompts. The computer may provide, for output via the metaverse environment, content generated based on the one or more tuned prompts.

### BACKGROUND

This disclosure relates to virtual worlds, and more specifically, to metaverse environment prompt tuning.

### SUMMARY

Some aspects described herein relate to a method. The method may include segmenting a metaverse environment into multiple virtual components that are associated with respective interaction modes. The method may include detecting a virtual interaction with a virtual component of the multiple virtual components, where the virtual interaction is associated with contextual information. The method may include identifying, based on detecting the virtual interaction, one or more prompt tuning parameters for a generative model, where the one or more prompt tuning parameters are based on the contextual information and an interaction mode associated with the virtual component. The method may include tuning, based on the one or more prompt tuning parameters, one or more prompts of the generative model to obtain one or more tuned prompts. The method may include providing, for output via the metaverse environment, content generated based on the one or more tuned prompts.

Some aspects described herein relate to a computer system. The computer system may include a processor set, one or more computer-readable storage media, and program instructions stored on the one or more computer-readable storage media to cause the processor set to perform operations. The operations may include assigning multiple virtual areas, of a metaverse environment, with one or more interaction modes. The operations may include detecting that an avatar of a user is within a virtual area of the multiple virtual areas, where the virtual area is associated with an interaction mode of the one or more interaction modes. The operations may include detecting a virtual interaction by the avatar within the virtual area, where the virtual interaction is associated with contextual information. The operations may include identifying, based on the virtual interaction and the interaction mode, one or more prompt tuning parameters for a generative model, where the one or more prompt tuning parameters are based on at least one of the contextual information or the interaction mode. The operations may include obtaining, based on the one or more prompt tuning parameters, one or more tuned prompts of the generative model. The operations may include providing, for output via the metaverse environment, content generated based on the one or more tuned prompts.

Some aspects described herein relate to a computer program product. The computer program product may include one or more computer-readable storage media and program instructions stored on the one or more computer-readable storage media to perform operations. The operations may include segmenting a metaverse environment into multiple virtual components that are associated with respective interaction modes. The operations may include detecting a virtual interaction with a virtual component of the multiple virtual components, where the virtual interaction is associated with contextual information. The operations may include identifying, based on detecting the virtual interaction, one or more prompt tuning parameters for a generative model, where the one or more prompt tuning parameters are based on at least one of the contextual information or an interaction mode associated with the virtual component. The operations may include tuning, based on the one or more prompt tuning parameters, one or more prompts of the generative model to obtain one or more tuned prompts. The operations may include providing, for output via the metaverse environment, content generated based on the one or more tuned prompts.

### BRIEF DESCRIPTION OF THE DRAWINGS

FIG. 1 is a diagram of an example computing environment for metaverse environment prompt tuning described herein.

FIGS. 2A-2C are diagrams of an example associated with metaverse environment prompt tuning.

FIG. 3 is a diagram of example components of a device associated with metaverse environment prompt tuning.

FIG. 4 is a flowchart of an example process associated with metaverse environment prompt tuning.

### DETAILED DESCRIPTION

The following detailed description of example implementations refers to the accompanying drawings. The same reference numbers in different drawings may identify the same or similar elements.

Virtual worlds, such as the metaverse, are digital environments that simulate real-world experiences or create new ones. The metaverse is a collective virtual shared space, created by the convergence of virtual reality (VR), augmented reality (AR), the internet, and other technologies. A metaverse environment enables users to interact with each other and digital objects in real time, and is used for various purposes, such as social interaction, entertainment, education, and/or collaboration.

In some examples, determining the context of an interaction in a metaverse environment can be challenging due to the dynamic and multifaceted nature of virtual interactions. For example, a user may be interacting with multiple virtual objects, avatars, and/or environments simultaneously, making it difficult to determine the specific context of a given interaction. Additionally, the virtual environment itself can change over time, with new objects, avatars, or events being introduced or modified in real-time. This can make it difficult for a computer to accurately determine the context of an interaction in a metaverse environment. Further, because the metaverse environment may be configured without boundaries and definitions between different virtual spaces and interactions, a computer may be unable to determine a context associated with an interaction in a given space within the metaverse environment. For example, a user may move seamlessly between different virtual areas, or engage in multiple conversations simultaneously, making it difficult to determine the specific context and purpose of a given interaction.

In virtual collaborative environments, such as a metaverse environment, interactions between users, virtual avatars, and/or generative model systems can be complex and context dependent. However, because of the difficulty and/or inability to determine the context of a given interaction in the metaverse environment, current techniques for prompting generative models (e.g., generative artificial intelligence (AI) models, such as large language models (LLMs)) may not include the context or purpose of a given virtual space or interaction, leading to inconsistent or inappropriate outputs. For example, the use of generative models in metaverse environments can result in mismatched or incongruous responses, such as formal outputs in informal settings or vice versa.

For example, the use of generative models in metaverse environments can lead to difficulties in managing the computational resources associated with content generation. For example, a generative model may produce outputs that are computationally intensive to render, or that require a large amount of memory to store and process. Because of the risk of an output of the generative model being inconsistent or inappropriate, a computer may needlessly consume resources (such as computing resources, memory resources, and/or energy resources) to generate content using the generative model, resulting in decreased performance, increased energy consumption, and/or overall system inefficiency.

Additionally, such use of generative models in metaverse environments can lead to difficulties in dynamically adapting content generated by a generative model to the changing needs and circumstances of virtual collaborations. For example, the generative model may produce outputs that are insensitive to the formality or informality of a given virtual space, or that fail to account for the specific goals or objectives of a particular collaboration. Additionally, because of the difficulty and/or inability to determine the context of a given interaction in the metaverse environment, the computer may be unable to prioritize tasks, allocate resources, and/or optimize a processing of workflows for content generation via the generative model. This can lead to decreased overall efficiency, increased latency, and/or a poor user experience.

Some implementations described herein enable prompt tuning for a generative model in a metaverse environment. For example, a computer (e.g., a server device) may segment a metaverse environment into multiple virtual components that are associated with respective interaction modes. “Interaction mode” refers to the context, purpose, and/or characteristic of user interactions with a given virtual component (e.g., with a virtual object or within a virtual area). In some examples, the virtual components may be segmented through the computer mapping the metaverse environment into multiple virtual areas, each with dedicated coordinates and attributes. The computer may use two-dimensional (2D) and/or three-dimensional (3D) spatial mapping techniques, such as grid-based and/or mesh-based mapping, to define the boundaries and properties of each virtual component. The computer may use the mapping to associate specific interaction modes with each virtual area, thereby enabling the computer to dynamically adjust prompt tuning parameters based on the location and interactions within the metaverse environment. The computer may detect a virtual interaction with a virtual component. For example, the computer may detect that an avatar for a user is within a given virtual area and/or that the avatar is interacting with a given virtual object. In some examples, the computer may determine or obtain contextual information associated with the interaction. The computer may identify one or more prompt tuning parameters for a generative model based on the contextual information and/or an interaction mode associated with the virtual component. The computer system may tune (e.g., modify or generate) one or more prompts of the generative model based on the one or more prompt tuning parameters to obtain one or more tuned prompts. As used herein, “prompt” may refer to input data or instructions that guide the generative model to generate content, such as text, images, and/or audio, among other examples. For example, a prompt may indicate context, a desired output, and/or other instructions for the generative model. The computer may generate content based on the one or more tuned prompts. The computer may provide, for display via the metaverse environment, the content.

As a result, the computer may apply context-aware prompt tuning for the generative models in the metaverse environment, enabling more accurate and relevant content generation based on user interactions and virtual context. By the computer dynamically adapting to the context and purpose of a given virtual space or interaction, the computer may optimize performance, reduce computational overhead, and/or reduce latency associated with content generation in the metaverse environment. For example, by the computer tuning the prompt(s) of the generative model using the one or more prompt tuning parameters (e.g., that are identified based on the interaction mode and/or contextual information of a given interaction), the computer may cause the generative model to output more accurate and relevant content for the given interaction within the metaverse environment.

This enables more efficient use of processing resources, memory resources, and/or network resources, among other examples, associated with content generation in the metaverse environment. By the computer providing more accurate and relevant content, the computer can reduce the likelihood of redundant processing, minimize the generation of irrelevant data, and/or optimize processing workflows, resulting in improvements in overall computer performance and efficiency. By the computer segmenting the metaverse environment into multiple virtual components, the computer can assign interaction mode(s) to each virtual component and can accurately track when an avatar is interacting in, or with, a given virtual component. This enables the computer to identify an interaction mode with a given virtual component in the metaverse environment.

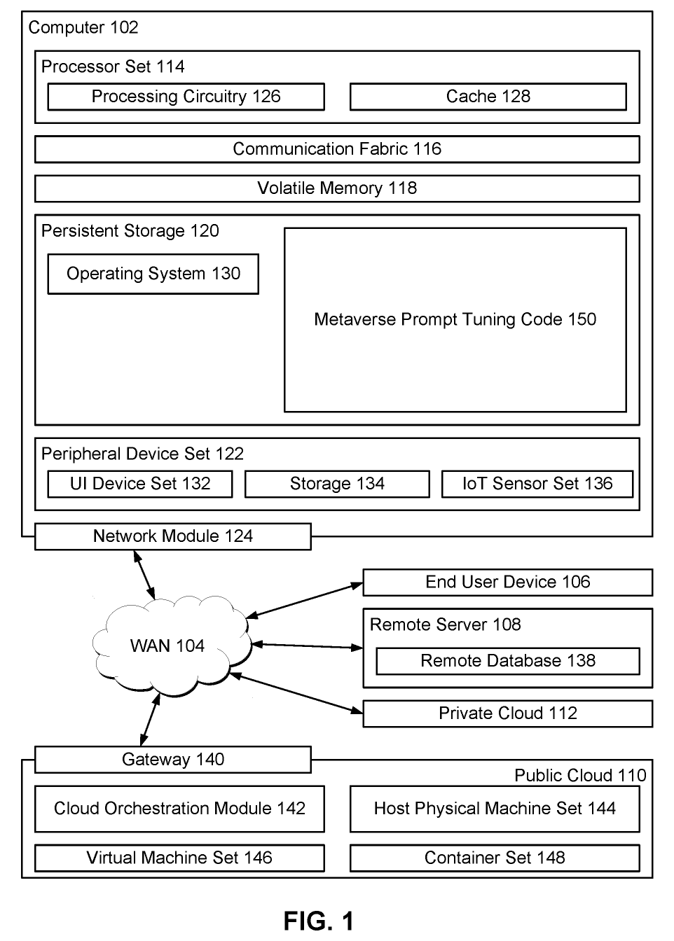

FIG. 1 is a diagram of an example computing environment 100 for metaverse environment prompt tuning described herein.

The computing environment 100 contains an example of an environment for the execution of at least some of the computer code involved in performing the inventive methods, such as metaverse prompt tuning code 150. In addition to the metaverse prompt tuning code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the metaverse prompt tuning code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in the metaverse prompt tuning code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the metaverse prompt tuning code 150 may include at least some of the computer code involved in performing one or more operations described herein. In some implementations, the operations may include segmenting a metaverse environment into multiple virtual components that are associated with respective interaction modes; detecting a virtual interaction with a virtual component of the multiple virtual components, wherein the virtual interaction is associated with contextual information; identifying, based on detecting the virtual interaction, one or more prompt tuning parameters for a generative model, where the one or more prompt tuning parameters are based on the contextual information and an interaction mode associated with the virtual component; tuning, based on the one or more prompt tuning parameters, one or more prompts of the generative model to obtain one or more tuned prompts; and/or providing, for output via the metaverse environment, content generated based on the one or more tuned prompts. In some implementations, the operations may include assigning multiple virtual areas, of a metaverse environment, with one or more interaction modes; detecting that an avatar of a user is within a virtual area of the multiple virtual areas, where the virtual area is associated with an interaction mode of the one or more interaction modes; detecting a virtual interaction by the avatar within the virtual area, where the virtual interaction is associated with contextual information; identifying, based on the virtual interaction and the interaction mode, one or more prompt tuning parameters for a generative model, where the one or more prompt tuning parameters are based on the contextual information and the interaction mode; obtaining, based on the one or more prompt tuning parameters, one or more tuned prompts of the generative model; and/or providing, for output via the metaverse environment, content generated based on the one or more tuned prompts.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

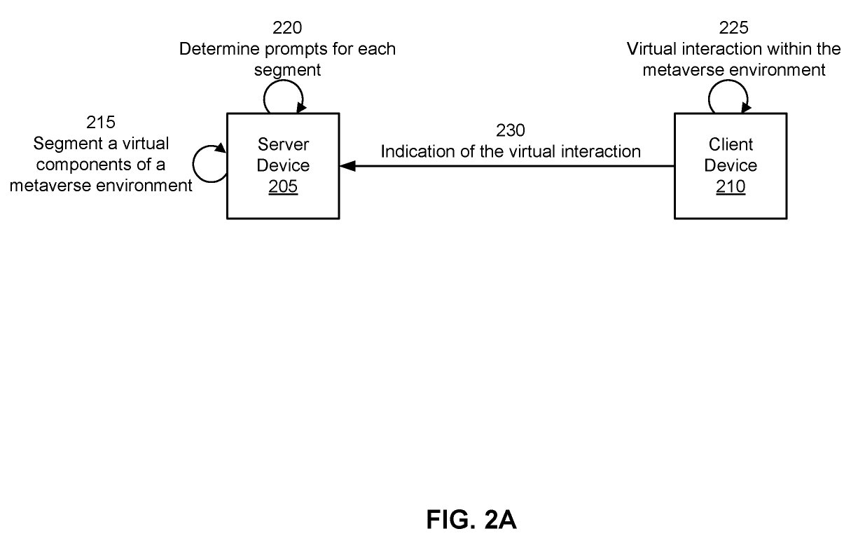

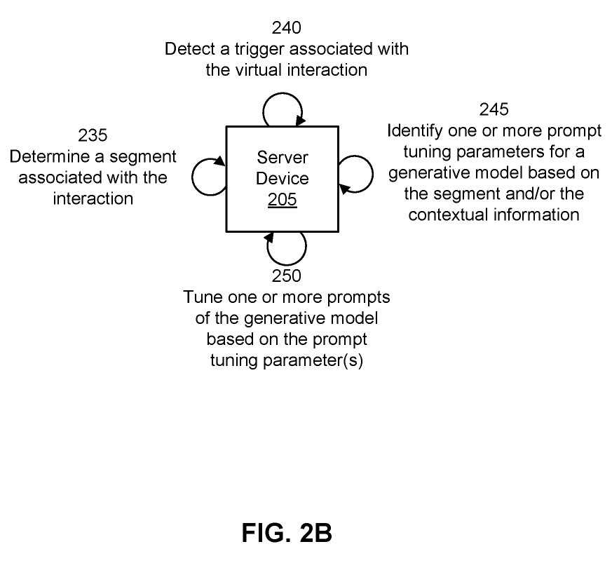

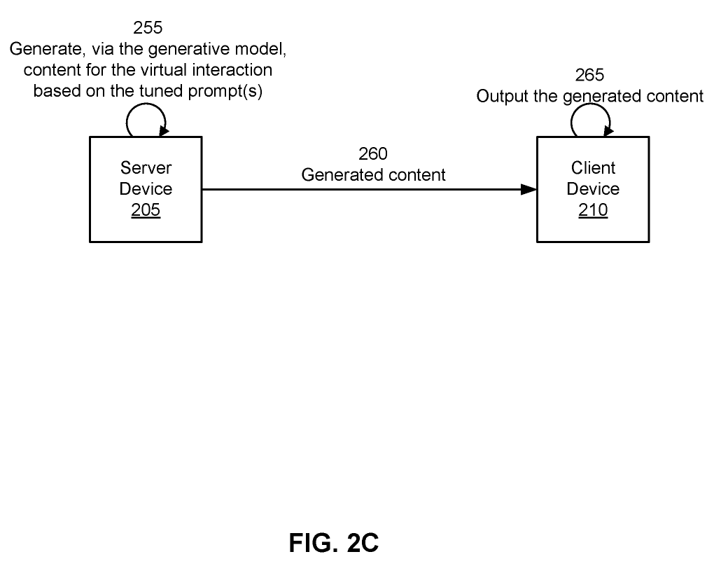

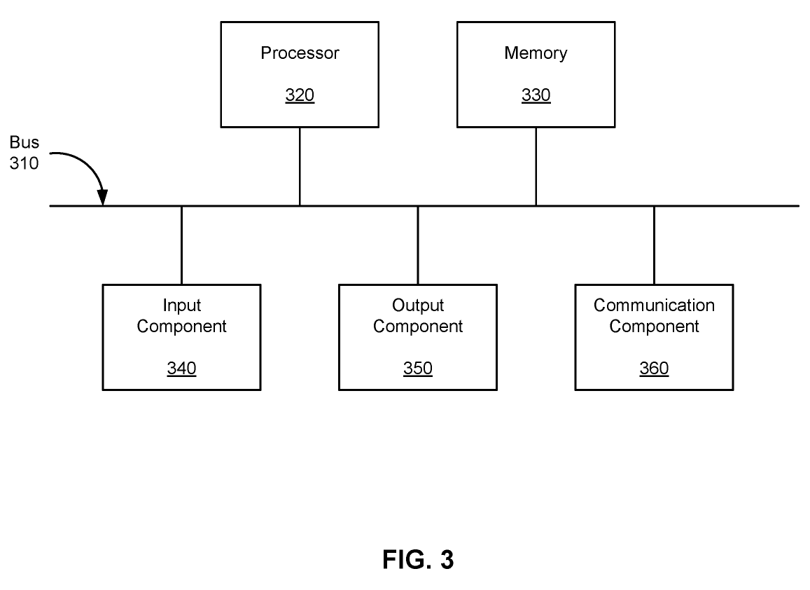

FIGS. 2A-2C are diagrams of an example 200 associated with metaverse environment prompt tuning. As shown in FIGS. 2A-2C, example 200 includes a server device 205 and a client device 210. These devices are described in more detail in connection with FIGS. 1 and 3. In some examples, the server device 205 is an example of a first computer 102 and the client device is an example of a second computer 102.

The server device 205 may be, or may include, a metaverse server. The metaverse server may be configured to host, manage, and/or facilitate metaverse collaboration sessions, such as generating and adapting personalized virtual layouts described herein. Additionally, the metaverse server may process user input, and/or synchronize interactions among multiple users in real-time, among other examples. Additionally, the metaverse server may perform user authentication, perform data storage for a metaverse environment or session, and/or generate, render, and/or arrange virtual objects and environments, among other examples. The client device 210 may be, or may include, a metaverse client. The metaverse client may be configured to render and/or display personalized virtual layouts received from a metaverse server (e.g., the server device), as described herein. Additionally, the metaverse client may capture and transmit user input, such as movements and interactions, to the server device 205 for processing. The metaverse client may perform local rendering of virtual objects, process sensory data, and/or provide real-time feedback to a user, among other examples.

As shown in FIG. 2A, and by reference number 215, the server device 205 may segment one or more virtual components in a metaverse environment. For example, the server device 205 may segment the metaverse environment into multiple virtual components. In this context, “virtual component” refers to a virtual area (e.g., a virtual room), a virtual object, a virtual asset, or another virtual component included in the metaverse environment. A segment may define a virtual component to be associated with prompt tuning, as described in more detail elsewhere herein. For example, a segment may define a virtual area in which the server device 205 is to apply prompt tuning for content output in the virtual area. As another example, a segment may define a virtual object to be associated with prompt tuning. For example, the virtual object may display, output, or provide content generated using a generative model. The segment may indicate that prompt tuning is to be applied for the content generated using a generative model.

The generative model may be a model configured to generate unique content based on, or in response to, an input (e.g., a prompt). For example, the generative model may be, or may include, a generative AI model, a language model, an LLM, a generative adversarial network (GAN), a variational autoencoder, a recurrent neural network, a transformer, a diffusion model, an autoregressive model, a generative moment matching network, a neural Turing machine, a generative stochastic network, a video generative model, or an image generative model, among other examples.

For example, the server device may receive a user input indicating a segment for a given virtual component. For example, a administrator (e.g., an administrator for the metaverse environment) may interact with a graphical user interface (GUI) to input segmentation information for the metaverse environment. The administrator may be an administrator for the metaverse environment, and a participant or user may be a user participating in, or interacting with, the metaverse environment. An avatar may be a virtual representation of a participant. The segmentation information may define a virtual closed loop boundary for a given virtual component. The administrator may access the GUI via the client device 210 or another device, such as a computer 102. Using the GUI, the administrator may select from a variety of tools and features to define the virtual closed loop boundary. For example, the administrator may use a 2D or 3D mapping tool to draw the virtual closed loop boundary, or select from pre-defined shapes and templates. The administrator can also use interactive tools, such as virtual reality gestures or voice commands, to define the virtual closed loop boundary.

The GUI may provide the administrator with various options and settings to customize the segmentation process. For example, the administrator may select the level of granularity for the segmentation, or choose to segment the metaverse environment based on criteria, such as user behavior, a time parameter, an event parameter, and/or virtual object characteristics, among other examples. The administrator can use the GUI to monitor and adjust the segmentation process in real-time, ensuring that the metaverse environment is optimized for the needs of the participants in the metaverse environment.

In some examples, the GUI may provide a mapping system to enable the administrator to translate a virtual boundary into digital coordinates. For example, the administrator can use a 2D or 3D mapping tool to assign coordinates (e.g., x, y, and z coordinates) to the virtual closed loop boundary. In some examples, the server device 205 may use one or more algorithms to automatically generate the digital coordinates based on the defined virtual closed loop boundary.

In some examples, the GUI may provide a preview view of the boundary of a defined segment. For example, after the virtual closed loop boundary has been translated into digital coordinates, the administrator can review and refine the results (e.g., the preview view) to ensure accuracy. The administrator can use the GUI to visualize the digital coordinates, making it easier to identify any errors or discrepancies in the segment for the virtual component.

With the digital coordinates determined, the administrator can interact with the GUI to mark the boundaries of the defined closed-loop area within the metaverse environment. This may include using visual markers or digital coordinates to indicate the boundaries of the segment within the metaverse environment. For example, the administrator may cause one or more markers to be placed within the metaverse environment to mark the boundaries of a segment, such as virtual flags, signs, or other visual indicators. Using the GUI, the administrator may assign one or more properties and/or attributes to the marked segments. For example, the administrator can designate a specific color or texture to the boundaries, or assign a specific sound or audio effect to indicate when a user or virtual object approaches or crosses the boundary of a segment. This allows the administrator to create a seamless and immersive experience for participants.

The marked boundaries may serve as a visual cue for participants in the metaverse environment, indicating the different segments within the metaverse environment. Participants can use this information to navigate the metaverse environment, find specific locations or objects, and/or interact with other participants or virtual objects within the designated segments. The marked boundaries also help to prevent users from entering restricted or unauthorized areas, ensuring that the metaverse environment remains secure and controlled.

In addition to defining the virtual closed loop boundary, the administrator can use the GUI to assign one or more properties and/or attributes to each virtual component. For example, the administrator can assign an interaction mode (such as formal or informal) to each virtual component, or designate specific virtual objects or assets to be included within each virtual component. This enables the administrator to tailor the metaverse environment to the specific needs and goals of the participants, and ensure that the environment is optimized for effective collaboration and interaction in association with generative model generated content.

For example, the server device 205 may segment the metaverse environment into multiple virtual components that are associated with respective interaction modes (e.g., as indicated or defined by the administrator via the GUI). For example, the server device 205 may segment the metaverse environment into multiple virtual areas, each associated with a specific interaction mode, such as a formal meeting area, an informal discussion area, or a cross-functional collaboration area, among other examples. The server device 205 may segment the metaverse environment into multiple virtual objects, each with a specific characteristic, such as a virtual whiteboard, a virtual presentation screen, or a virtual interactive tool, via which content is output. The segment of a virtual object may indicate that content output via the characteristic is to be associated with prompt tuning.

The segmentation of the metaverse environment into multiple virtual components enables the server device 205 to tailor the interactions within each component to the interaction type of participants for the virtual component in the metaverse environment. For example, the server device 205 may configure a segment associated with a virtual meeting area to have prompt tuning parameters resulting in a formal tone for output from the generative mode, with virtual objects and assets that support formal presentations and discussions. In contrast, the server device 205 may configure a segment associated with a virtual discussion area to have prompt tuning parameters resulting in an informal tone or relaxed tone for output from the generative mode, with virtual objects and assets that support informal conversations and brainstorming.

The server device 205 may obtain digital coordinates for respective segments (e.g., based on the administrator input to the GUI). For example, the digital coordinates may define the boundaries of a 3D space or a 2D space. The boundaries may define a given segment. The server device 205 may store the digital coordinates of the boundaries to enable the server device 205 to identify when a participant is interacting within, or in association with, a given segment.

For example, to improve the likelihood of accurate tracking and rendering of the segments, the server device 205 may implement a mapping system that translates 2D boundaries, wall space boundaries, and/or 3D space boundaries into digital coordinates within the metaverse environment. The mapping system uses various algorithms and techniques, such as spatial analysis or machine learning, to convert the boundaries into digital coordinates. The mapping system for 2D boundaries may include assigning x and y coordinates to a virtual space, while the mapping system for wall space boundaries involves assigning x, y, and z coordinates to the virtual space. The mapping system for 3D space boundaries involves assigning x, y, and z coordinates to the virtual space, as well as defining the length, width, and height of the space. The server device 205 may use these digital coordinates to track the segments within the metaverse environment. The server device 205 may use various algorithms and techniques, such as spatial tracking or object recognition, to monitor the positions and movements of participants and virtual objects within the segments.

As shown by reference number 220, the server device 205 may determine one or more prompts for each segment. The server device 205 may determine one or more prompts (e.g., a library of prompts) for a given segment based on the interaction mode assigned to the segment. For example, the server device 205 may store, or may have access to, different sets of prompts for respective interaction modes. This enables the server device 205 to provide a tailored and context-specific experience for participants within each segment.

For example, the one or more prompts for a given interaction mode may be designed or configured to result in output from the generative model that is in accordance with, or relevant to, the interaction mode. For example, if the interaction mode is a formal discussion, the one or more prompts may be designed or configured to result in output that uses a formal tone or style. As another example, if the interaction mode is a collaborative discussion, the one or more prompt may be designed or configured to result in output that uses an informal tone or style. As another example, the interaction mode may be associated with a given knowledge domain, and the one or more prompts may be designed or configured to provide information for the given knowledge domain as context for the generative model.

As shown by reference number 225, a participant may initiate a virtual interaction within the metaverse environment via the client device 210. For example, the participant may use the client device 210 to cause an avatar to move within the metaverse environment. As another example, the participant may use the client device 210 to cause the avatar to interact with a given virtual object. As another example, the participant may provide input (e.g., text input, voice input, or another input) that is to be output in the metaverse environment. As shown by reference number 230, the client device 210 may transmit, and the server device 205 may receive, an indication of the virtual interaction. For example, the server device 205 may detect a virtual interaction with a virtual component of the multiple virtual components. The virtual component may be associated with a segment.

In some examples, the virtual interaction may be associated with contextual information. The contextual information may include information indicating participant information, such as an identity, role, or preferences. Additionally, or alternatively, the contextual information may include information about the virtual environment, such as a location, time of day, and/or an event, among other examples, associated with the virtual interaction. In some examples, the contextual information may include information about the previous interactions by the participant, such as conversation history or past behaviors, which can be used to inform the prompts and responses generated by the server device 205. The contextual information may also include external data, such as weather, news, or social media updates, which can be used to add depth and relevance to the interactions within the metaverse environment. For example, if the virtual interaction includes an interaction with a virtual object (such as a virtual whiteboard) that includes writing a message, the contextual information may include the text of the message, the location of the virtual whiteboard within the metaverse environment, and/or an ongoing discussion of which the message is a part, among other examples. As another example, if the participant attends a virtual event and the virtual interaction occurs as part of the virtual event, such as a conference or meeting, the contextual information may include the agenda, speaker list, and presentations associated with the event. By taking into account this contextual information, the server device 205 can provide more personalized, relevant, and engaging interactions for participants, and can create a more immersive and realistic experience within the metaverse environment.

As shown in FIG. 2B, and by reference number 235, the server device 205 may determine a segment that is associated with the virtual interaction. For example, the server device 205 may determine a virtual component (e.g., a virtual area or a virtual object) that is associated with the virtual interaction. For example, the server device 205 may track a position of the avatar of the participant within the virtual environment. In some examples, the server device 205 may monitor the movements and positions of avatars within the metaverse environment. In some examples, the tracking by the server device 205 may include spatial tracking or object recognition, to monitor the position of virtual objects within the metaverse environment. This enables the server device 205 to determine the locations of participant within the virtual environment and identify which virtual component(s) the participant are interacting with. By the server device 205 tracking the positions of virtual objects and participant within the metaverse environment, the server device 205 can determine the segment that is associated with the virtual interaction and provide context-specific interactions and responses using a tuned generative model.

For example, the server device 205 may detect that an avatar has crossed a boundary associated with a given segment (e.g., has entered into a virtual area associated with the segment) based on the virtual interaction. As another example, the server device 205 may detect that the avatar has interacted with a virtual object that is included in, or mapped to, a segment. This enables the server device 205 to apply prompt tuning in accordance with an interaction mode that is assigned to the segment.

As shown by reference number 240, the server device 205 may detect a trigger event associated with content generation. For example, the server device 205 may detect that an avatar of a participant is within a virtual area of the multiple virtual areas (e.g., as described in connection with reference number 235). The server device may detect, while the avatar is within the virtual area, a trigger event for content generation by the generative model. For example, the contextual information described above may be associated with the trigger event and the interaction mode. The trigger event may be based on one or more factors, such as a behavior, a conversation history, or a status of the metaverse environment, among other examples. In some examples, the trigger event may be an action performed by the participant, such as interacting with a virtual object or interacting with another avatar.

In some examples, the trigger event may be associated with a discussion associated with the avatar. For example, the server device 205 may detect, via natural language processing of a discussion associated with the participant, a discussion topic that is associated with content generation by the generative model. The natural language processing may involve analyzing a conversation history to identify keywords, sentiment, and/or intent, among other examples that are relevant to content generation. In some examples, the server device 205 may analyze participant preferences, interests, and/or goals to determine the trigger event. For example, if the participant is discussing a product, the server device 205 may detect a trigger event to generate content related to that product, such as a virtual demonstration or a list of features. As another example, the participant may initiation a discussion related to a product specification or a project milestone. The trigger may cause the server device 205 to generate content (e.g., in accordance with the interaction mode for the segment associated with the virtual interaction) for the product specification or project milestone. By detecting trigger events based on the participant’s interactions and conversations, the server device 205 can provide more relevant and timely content to the participant, enhancing the overall experience within the metaverse environment.

In some examples, the trigger event may be based on an interaction with a virtual object in the metaverse environment. For example, the server device 205 may detect an interaction with a virtual object in the virtual area that is associated with content generation by the generative model. The virtual object may be a 3D model, a virtual tool, or a digital entity that the participant can interact with in the metaverse environment. The interaction with the virtual object may be a click, a touch, a gesture, a voice input, a text input, or any other type of input that the participant provides. For example, if the u participant ser clicks on a virtual product in a virtual showroom, the server device 205 may detect a trigger event to generate content related to that product, such as a product description, a price, or a review.

The interaction with the virtual object may also trigger a type of content generation. For example, if the participant interacts with a virtual whiteboard in a virtual classroom, the server device 205 may detect a trigger event to generate educational content, such as a lesson plan, a diagram, or a video lecture. In some examples, the interaction with the virtual object may trigger a series of events, such as a simulation, a game, or a tutorial. By detecting trigger events based on interactions with virtual objects, the server device 205 can provide more immersive and interactive experiences within the metaverse environment, allowing participants to engage with virtual content in a more natural and intuitive way.

As shown by reference number 245, the server device 205 may identify one or more prompt tuning parameters for the generative model. The server device 205 may identify the one or more prompt tuning parameters based on the segment in which the virtual interaction (e.g., described in connection with reference number 225, reference number 235, and reference number 240) occurred. For example, the segment may be associated with, mapped to, or assigned to an interaction mode. The one or more prompt tuning parameters may be associated with the interaction mode. For example, the one or more prompt tuning parameters may be associated with the interaction mode in that the one or more prompt tuning parameters may cause prompts to be tuned to generate an output that is in accordance with a tone, style, knowledge domain, or formality level, among other examples, indicated by the interaction mode.

In some examples, the server device 205 may identify the one or more prompt tuning parameters based on the contextual information. For example, the contextual information may indicate a topic or event associated with the virtual interaction. The server device 205 may identify one or more prompt tuning parameters that cause prompts to be tuned to generate an output that is in accordance with a tone, style, knowledge domain, or formality level, among other examples, associated with the topic or event. As another example, the contextual information may indicate a tone, style, knowledge domain, sentiment, or formality level, among other examples, of the virtual interaction. The server device 205 may identify one or more prompt tuning parameters that cause prompts to be tuned to generate an output that is in accordance with the tone, the style, the knowledge domain, the sentiment, or the formality level indicated by the contextual information.

A prompt tuning parameter may include a parameter associated with modifying or generating (e.g., tuning) a prompt for the generative model. For example, a prompt tuning parameter may include a formality level, a tone parameter, a knowledge domain, a language style, and/or a persona parameter, among other examples. The formality level parameter may indicate the level of formality in generated content, such as formal or informal. For example, if the participant is in a virtual meeting room, the server device 205 may set the formality level parameter to formal, resulting in more professional and polished language in the generated content. In other examples, if the participant is in a virtual social lounge, the server device 205 may set the formality level parameter to informal, resulting in more casual and conversational language in the generated content.

The tone parameter may indicate an emotional tone or attitude conveyed in generated content, such as friendly, sarcastic, or enthusiastic, among other examples. The knowledge domain parameter may indicate the subject matter or domain of generated content, such as history, science, entertainment, a given product, a given event, a given company, or another knowledge domain. The knowledge domain may include information that can be provided as context for the generative model to enable the generative model to generate content more relevant to the knowledge domain. The language style parameter may indicate a linguistic style or syntax of generated content, such as simple or complex sentences, idiomatic expressions, or colloquialisms, among other examples. The persona parameter may indicate a personality or character traits of generated content, such as humor, empathy, or authority, among other examples. By identifying the one or more prompt tuning parameters, the server device 205 can cause the generative model to generate content that is tailored to the specific context and requirements of the participant, resulting in a more personalized and engaging experience within the metaverse environment.

As shown by reference number 250, the server device 205 may tune one or more prompts of the generative model based on the one or more prompt tuning parameters. This enables the server device 205 to obtain one or more tuned prompts. As used herein, “tuning” a prompt may refer to modifying an existing prompt or generating a new prompt based on an existing prompt (e.g., modifying or mutating an existing text of a prompt). For example, if the virtual interaction is in a virtual meeting room, the server device 205 may tune a prompt to include more formal language and industry-specific terminology, resulting in more professional and relevant content. As another example, if the virtual interaction is in a virtual social lounge, the server device 205 may tune the prompt to include more casual language or a humorous tone, resulting in more engaging and entertaining content.

In some examples, “tuning” a prompt may refer to providing context to the generative model prior to providing the prompt as input. This may involve feeding the generative model with information or data related to the context, such as participant preferences, conversation history, or the status of the metaverse environment or an event occurring in the metaverse environment, among other examples. For example, if the virtual interaction involves discussing a given product, the server device 205 may provide context to the generative model about the features, pricing, and/or reviews, among other examples, of the product. This may result in more accurate and informative content generated by the generative model. Similarly, if the virtual interaction occurs in a virtual classroom, the server device 205 may provide context to the generative model about a lesson plan, a progress of the participant, and/or the subject matter being taught or explained, resulting in more effective and personalized learning materials.

In some examples, “tuning” a prompt may also refer to providing instructions to the generative model prior to providing the prompt as input. This may involve the server device 205 indicating a desired tone, style, or format of generated content, such as a formal report, a creative story, or a conversational dialogue, among other examples. For example, if the virtual interaction occurs in a virtual brainstorming session, the server device 205 may instruct the generative model to produce a list of innovative ideas, whereas if the virtual interaction occurs as part of a virtual debate, the server device 205 may instruct the generative model to produce counterarguments and/or supporting evidence.

As another example, prompt tuning may also involve training the generative model using prompts or by providing example input-output pairs to a context or instructions for the generative model. For example, if the virtual interaction occurs in association with a formal setting (e.g., in a segment assigned with a formal interaction mode), then the server device 205 may train the generative model on a dataset of formal business reports, resulting in more professional and polished content. As another example, if the virtual interaction occurs in association with an informal setting (e.g., in a segment assigned with an informal interaction mode), then the server device 205 may train the generative model on a dataset of conversational dialogues, resulting in more natural and engaging content. By tuning the prompts and providing context and instructions to the generative model, the server device 205 can cause the generative model to generate content that is tailored to the specific needs and requirements of the participant, resulting in a more effective and enjoyable experience within the metaverse environment.

In some examples, prompt tuning may include the server device providing at least a portion of the contextual information as context for the generative model. For example, the server device 205 may provide the generative model with details about the environment, such as a location, time of day, or current activity, to influence the content generation process. For example, if the virtual interaction occurs in a virtual coffee shop, the server device 205 may provide contextual information about the coffee shop’s atmosphere, such as the background noise, lighting, or temperature, to aid the generative model in creating content for a more immersive and realistic experience. By providing this contextual information, the server device 205 can provide the generative model with more relevant context, resulting in more tailored and relevant content that enhances the overall metaverse experience. This approach enables the generative model to adapt to the dynamic nature of the metaverse environment and respond accordingly, creating a more seamless and engaging interaction between the participant and the virtual world.

In some examples, prompt tuning may include the server device selecting (or obtaining) a prompt (e.g., a tuned prompt) from a set of prompts that is associated with a given interaction mode. The given interaction mode may be the interaction mode mapped to, or assigned to, the segment in which the virtual interaction occurs. For example, as described elsewhere herein, the server device may store sets of prompts associated with respective interaction modes. To tune the prompts, the server device 205 may identify a set of prompts (e.g., from a library of prompts) that is associated with the given interaction mode. The server device 205 may select one or more prompts, from the set of prompts, to provide to the generative model. In some examples, the server device 205 may select the one or more prompts based on the contextual information of the virtual interaction. This enables the server device 205 to select one or more prompts that are in accordance with the interaction mode of the virtual interaction and relevant to the context of the virtual interaction.

In some examples, the server device 205 may tune the one or more prompts based on, or in response to, detecting the trigger (e.g., as described in connection with reference number 240). For example, the server device 205 may perform prompt tuning based on, or in response to, detecting that an avatar is within a virtual area associated with a segment and detecting a virtual interaction associated with a trigger for content generation. This may cause the server device to perform prompt tuning based on an interaction mode associated with the virtual area and based on contextual information associated with the virtual interaction.

In some examples, the tuning of the one or more prompts (or obtaining of the one or more tuned prompts) may be based on the virtual interaction occurring during an event that is associated with prompt tuning, or during a time period that is associated with prompt tuning. For example, the server device 205 may adjust the prompt tuning according to a schedule or occurring events, allowing for more dynamic and flexible content generation. For example, during a virtual conference, the server device 205 may tune the prompts to be more formal and professional, whereas during a virtual social gathering (e.g., in the same virtual area or the same metaverse environment as the virtual conference, but at a different time), the server device 205 may tune the prompts to be more casual and conversational. Similarly, during a virtual training session, the server device 205 may tune the prompts to focus on the topic being taught, whereas during a virtual brainstorming session (e.g., in the same virtual area or the same metaverse environment as the virtual training session, but at a different time), the server device 205 may tune the prompts to encourage creativity and out-of-the-box thinking.

The prompt tuning may be aligned with time ranges or schedules. For example, during peak hours, the server device 205 may tune the prompts to prioritize efficiency and productivity, whereas during off-peak hours, the server device 205 may tune the prompts to prioritize relaxation and leisure. Additionally, the prompt tuning can be event-based, such as during holidays, celebrations, or special occasions. For example, during a virtual New Year’s Eve party, the server device 205 may tune the prompts to focus on festive themes, decorations, and entertainment. This enables the server device 205 to dynamically identify which prompt tuning is to be selected for any specific segmented virtual space in the metaverse environment based on the identified criteria.

As shown in FIG. 2C, and by reference number 255, the server device 205 may generate, via the generative model, content for the virtual interaction based on the one or more tuned prompts. The content may include text, one or more images, one or more videos, audio, a virtual object, and/or a virtual asset, among other examples. For example, the server device 205 may provide, to the generative model, the one or more tuned prompts as an input. The server device 205 may obtain, from the generative model, the content as an output (e.g., based on, or in response to, the one or more tuned prompts as the input). This enables the server device 205 to generate a range of content that is tailored to meet the needs and requirements of the participant. For example, if the virtual interaction occurs in a virtual art studio, the server device 205 may generate content that includes one or more virtual objects, such as a virtual canvas, paints, and/or brushes, enabling the participant to create artwork.

The content generated by the generative model may be interactive, enabling the participant to engage with generated content in a more immersive way. For example, the server device 205 may generate a virtual 3D model of a product, enabling the participant to rotate, zoom, and explore the product from different angles. As another example, the server device 205 may generate a virtual environment that includes interactive elements, such as virtual buttons, levers, or puzzles, that the participant can manipulate to achieve a specific goal.

The content generated by the generative model may be dynamic and adaptive, changing in response to the interactions and feedback from the participant. For example, if the participant is in a virtual conversation with a virtual assistant, the server device 205 may generate content that responds to questions and/or statements from the participant, adapting the tone and style of the conversation based on the interaction mode of the segment in which the virtual interaction (e.g., the conversation) is occurring. This enables a more natural and intuitive interaction between the participant and the virtual environment, blurring the line between the physical and virtual worlds.

As shown by reference number 260, the server device 205 may provide the generated content for output in the metaverse environment. For example, the server device 205 may transmit, and the client device 210 may receive, information that enables the client device 210 to output the generated content. For example, the client device 210 may render or otherwise generate display information based on the generated content. As shown by reference number 265, the client device 210 may output the generated content. For example, the client device 210 may display the generated content in the metaverse environment. As another example, the client device may output audio indicating the generated content in connection with the virtual interaction in the metaverse environment. As another example, the client device 210 may display content via a virtual object included in the metaverse environment (e.g., included in a virtual area in which the virtual interaction occurs), such as via a virtual display screen, a virtual whiteboard, or another virtual object. For example, the server device 205 may cause the content to be output via the virtual object included in the virtual area (e.g., by providing the generated content to the client device 210).

As indicated above, FIGS. 2A-2C are provided as an example. Other examples may differ from what is described with regard to FIGS. 2A-2C.

FIG. 3 is a diagram of example components of a device 300 associated with metaverse environment prompt tuning. The device 300 corresponds to one or more of the computer 102, a component or device depicted in FIG. 1, the server device 205, or the client device 210. In some implementations, the computer 102, a component or device depicted in FIG. 1, the server device 205, or the client device 210 includes one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

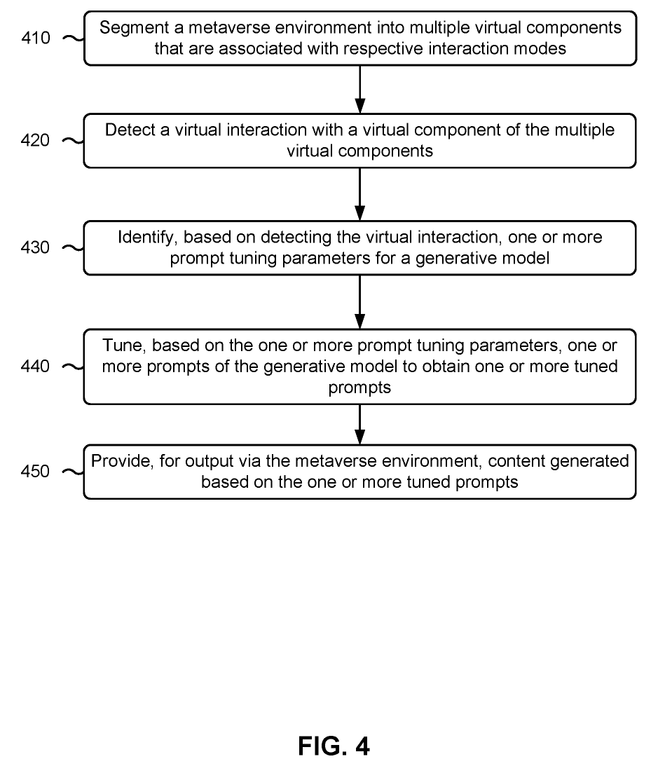

FIG. 4 is a flowchart of an example process 400 associated with metaverse environment prompt tuning. One or more process blocks of FIG. 4 are performed by a server device (e.g., server device 205) and/or by another device or a group of devices separate from or including the server device, such as a client device (e.g., the client device 210), a computer (e.g., a computer 102), or another device or component, such as a device or component depicted in FIG. 1. Additionally, or alternatively, one or more process blocks of FIG. 4 may be performed by one or more components of device 300, such as processor 320, memory 330, input component 340, output component 350, and/or communication component 360.

As shown in FIG. 4, process 400 includes segmenting a metaverse environment into multiple virtual components that are associated with respective interaction modes (block 410). For example, the server device may segment a metaverse environment into multiple virtual components that are associated with respective interaction modes, as described above.

As further shown in FIG. 4, process 400 includes detecting a virtual interaction with a virtual component of the multiple virtual components (block 420). For example, the server device may detect a virtual interaction with a virtual component of the multiple virtual components, as described above. In some implementations, the virtual interaction is associated with contextual information.

As further shown in FIG. 4, process 400 includes identifying, based on detecting the virtual interaction, one or more prompt tuning parameters for a generative model (block 430). For example, the server device may identify, based on detecting the virtual interaction, one or more prompt tuning parameters for a generative model, as described above. In some implementations, the one or more prompt tuning parameters are based on the contextual information and/or an interaction mode associated with the virtual component.

As further shown in FIG. 4, process 400 includes tuning, based on the one or more prompt tuning parameters, one or more prompts of the generative model to obtain one or more tuned prompts (block 440). For example, the server device may tune, based on the one or more prompt tuning parameters, one or more prompts of the generative model to obtain one or more tuned prompts, as described above.

As further shown in FIG. 4, process 400 includes providing, for output via the metaverse environment, content generated based on the one or more tuned prompts (block 450). For example, the server device may provide, for output via the metaverse environment, content generated based on the one or more tuned prompts, as described above.

Process 400 may include additional aspects, such as any single aspect or any combination of aspects described below and/or in connection with one or more other processes described elsewhere herein.

In a first aspect, the multiple virtual components include multiple virtual areas of the metaverse environment, and detecting the virtual interaction with the virtual component includes detecting that an avatar of a user is within a virtual area of the multiple virtual areas, wherein the virtual area is associated with the interaction mode, and detecting, while the avatar is within the virtual area, a trigger event for content generation by the generative model, where the contextual information is associated with the trigger event and the interaction mode.

In a second aspect, alone or in combination with the first aspect, the detecting of the trigger event includes at least one of detecting, via natural language processing of a discussion associated with the user, a discussion topic that is associated with content generation by the generative model, or detecting an interaction with a virtual object in the virtual area that is associated with content generation by the generative model.

In a third aspect, alone or in combination with one or more of the first and second aspects, the interaction mode indicates a category of collaboration to occur in association with the virtual component.

In a fourth aspect, alone or in combination with one or more of the first through third aspects, the multiple virtual components are associated with respective sets of one or more prompts from multiple sets of one or more prompts, where the virtual component is associated with a set of one or more prompts from the multiple sets of one or more prompts, where the set of one or more prompts includes the one or more prompts, and where the set of one or more prompts is associated with the interaction mode.

In a fifth aspect, alone or in combination with one or more of the first through fourth aspects, process 400 includes selecting the one or more prompts, from the set of one or more prompts, based on the contextual information.

In a sixth aspect, alone or in combination with one or more of the first through fifth aspects, the tuning of the one or more prompts includes modifying the one or more prompts based on the contextual information and the interaction mode.

In a seventh aspect, alone or in combination with one or more of the first through sixth aspects, the tuning of the one or more prompts is based on the virtual interaction occurring during an event that is associated with prompt tuning, or during a time period that is associated with prompt tuning.

In an eighth aspect, alone or in combination with one or more of the first through seventh aspects, the one or more prompt tuning parameters include at least one of a formality level, a tone parameter, a knowledge domain, a language style, or a persona parameter.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
segmenting a metaverse environment into multiple virtual components that are associated with respective interaction modes;
detecting a virtual interaction with a virtual component of the multiple virtual components, wherein the virtual interaction is associated with contextual information;
identifying, based on detecting the virtual interaction, one or more prompt tuning parameters for a generative model, wherein the one or more prompt tuning parameters are based on the contextual information and an interaction mode associated with the virtual component;
tuning, based on the one or more prompt tuning parameters, one or more prompts of the generative model to obtain one or more tuned prompts; and
providing, for output via the metaverse environment, content generated based on the one or more tuned prompts.

2. The method of claim 1, wherein the multiple virtual components include multiple virtual areas of the metaverse environment, and wherein the detecting the virtual interaction with the virtual component comprises:
detecting that an avatar of a user is within a virtual area of the multiple virtual areas, wherein the virtual area is associated with the interaction mode; and
detecting, while the avatar is within the virtual area, a trigger event for content generation by the generative model, wherein the contextual information is associated with the trigger event and the interaction mode.

3. The method of claim 2, wherein the detecting of the trigger event comprises at least one of:
detecting, via natural language processing of a discussion associated with the user, a discussion topic that is associated with content generation by the generative model, or
detecting an interaction with a virtual object in the virtual area that is associated with content generation by the generative model.

4. The method of claim 1, wherein the interaction mode indicates a category of collaboration to occur in association with the virtual component.

5. The method of claim 1, wherein the multiple virtual components are associated with respective sets of one or more prompts from multiple sets of one or more prompts, wherein the virtual component is associated with a set of one or more prompts from the multiple sets of one or more prompts, wherein the set of one or more prompts includes the one or more prompts, and wherein the set of one or more prompts is associated with the interaction mode.

6. The method of claim 5, further comprising:
selecting the one or more prompts, from the set of one or more prompts, based on the contextual information.

7. The method of claim 1, wherein the tuning of the one or more prompts comprises:
modifying the one or more prompts based on the contextual information and the interaction mode.

8. The method of claim 1, wherein the tuning of the one or more prompts is based on the virtual interaction occurring during an event that is associated with prompt tuning, or during a time period that is associated with prompt tuning.

9. The method of claim 1, wherein the one or more prompt tuning parameters include at least one of:
a formality level,
a tone parameter,
a knowledge domain,
a language style, or
a persona parameter.

10. A computer system comprising:
a processor set;
one or more computer-readable storage media; and
program instructions stored on the one or more computer-readable storage media to cause the processor set to perform operations comprising:
assigning multiple virtual areas, of a metaverse environment, with one or more interaction modes;
detecting that an avatar of a user is within a virtual area of the multiple virtual areas, wherein the virtual area is associated with an interaction mode of the one or more interaction modes;
detecting a virtual interaction by the avatar within the virtual area, wherein the virtual interaction is associated with contextual information;
identifying, based on the virtual interaction and the interaction mode, one or more prompt tuning parameters for a generative model, wherein the one or more prompt tuning parameters are based on at least one of the contextual information or the interaction mode;
obtaining, based on the one or more prompt tuning parameters, one or more tuned prompts of the generative model; and
providing, for output via the metaverse environment, content generated based on the one or more tuned prompts.

11. The computer system of claim 10, wherein the detecting the virtual interaction comprises:
detecting a trigger event for content generation by the generative model, wherein the contextual information is associated with at least one of the trigger event or the interaction mode.

12. The computer system of claim 11, wherein the detecting of the trigger event comprises at least one of:
detecting, via natural language processing of a discussion associated with the user, a discussion topic that is associated with content generation by the generative model, or
detecting an interaction with a virtual object in the virtual area that is associated with content generation by the generative model.

13. The computer system of claim 10, wherein the multiple virtual areas are associated with respective sets of one or more prompts from multiple sets of one or more prompts, wherein the virtual area is associated with a set of one or more prompts from the multiple sets of one or more prompts, and wherein the one or more tuned prompts are based on one or more prompts included in the set of one or more prompts.

14. The computer system of claim 10, wherein the providing of the content comprises:
causing the content to be output via a virtual object included in the virtual area.

15. The computer system of claim 10, wherein the obtaining of the one or more tuned prompts comprises:
modifying one or more prompts based on the contextual information and the interaction mode.

16. The computer system of claim 10, wherein the obtaining of the one or more tuned prompts is based on the virtual interaction occurring during an event that is associated with prompt tuning, or during a time period that is associated with prompt tuning.

17. The computer system of claim 10, wherein the one or more prompt tuning parameters include at least one of:
a formality level, or
a knowledge domain.

18. A computer program product comprising:
one or more computer-readable storage media; and
program instructions stored on the one or more computer-readable storage media to perform operations comprising:
segmenting a metaverse environment into multiple virtual components that are associated with respective interaction modes;
detecting a virtual interaction with a virtual component of the multiple virtual components, wherein the virtual interaction is associated with contextual information;
identifying, based on detecting the virtual interaction, one or more prompt tuning parameters for a generative model, wherein the one or more prompt tuning parameters are based on at least one of the contextual information or an interaction mode associated with the virtual component;
tuning, based on the one or more prompt tuning parameters, one or more prompts of the generative model to obtain one or more tuned prompts; and
providing, for output via the metaverse environment, content generated based on the one or more tuned prompts.

19. The computer program product of claim 18, wherein the multiple virtual components include multiple virtual areas of the metaverse environment, and wherein the detecting the virtual interaction with the virtual component comprises:
detecting that an avatar of a user is within a virtual area of the multiple virtual areas, wherein the virtual area is associated with the interaction mode; and
detecting, while the avatar is within the virtual area, a trigger event for content generation by the generative model, wherein the contextual information is associated with the trigger event and the interaction mode.

20. The computer program product of claim 19, wherein the detecting of the trigger event comprises:
detecting, via natural language processing of a discussion associated with the user, a discussion topic that is associated with content generation by the generative model.
